(19) United States
(12) Patent Application Publication
(10) Pub. No.: US 2023/0121618 A1
(43) Pub. Date: Apr. 20, 2023

(54) REACTIONS OF FAILED ATTEMPTS DURING POINTS OF GAMEPLAY

(71) Applicant: Sony Interactive Entertainment Inc., Tokyo (JP)

(72) Inventor: Olga Rudi, San Mateo, CA (US)

(21) Appl. No.: 17/487,234

(22) Filed: Sep. 28, 2021

(51) Int. Cl. A63F 13/497; A63F 13/798; A63F 13/46

(52) U.S. Cl. CPC A63F 13/497; A63F 13/46; A63F 13/798; A63F 2300/558; A63F 2300/634

(57) ABSTRACT

A method and system for integrating media of past gameplay into overlays is disclosed. A plurality of trigger points associated with one or more interactive content titles is stored. Each trigger point is associated with a plurality of possible results of an activity in a respective interactive content title. Each of the possible results associated with one or more media files depicting the associated result of the activity. Gameplay data sent over a communication network of a current activity is monitored. The monitored gameplay data that indicates a possible result associated with the current activity is identified. The stored media files is filtered based on the identified result of the identified trigger point associated with the current activity. An overlay display of at least one of the filtered media files is generated and provided to the client device for presentation in association with the current gameplay session.

### BACKGROUND OF THE INVENTION

### 1. Field of Invention

The present invention generally relates to displaying past gameplay at trigger points. More specifically, the present invention relates to displaying media files associated with past gameplay identifying a past activity associated with a trigger point of a current activity.

### 2. Description of the Related Art

Presently available interactive media titles, including video game titles, may be recorded as user-generated content (UGC) that depict gameplay by players. Such recorded UGC may then by propagated to a variety of channels (e.g., social media, third-party applications) to be viewed by others. By circulating the UGC to others, players can share edifying, funny, or otherwise notable moments in the game environment during gameplay that others can find useful or entertaining. Such examples of UGC may be made available to users based on specific searches (e.g., for specific game titles, specific levels, specific in-game events and attempts, etc.) or more random browsing.

Some UGC may be of interest to users, for example, because of an particularly rare difficulty level, unusual in-game maneuvers, or a combination of inputs that had an unexpected result. Others may be funny and become viral, for example, where the player’s earnest attempt at beat a boss ends up failing miserably despite having all the right weapons and powers. In other situations, players may find it useful to observe how others have played the same game title in the past. Specifically, a player having difficulty navigating a particular portion of the game title may derive useful tips and insights from UGC of past gameplay that resulted in successful outcomes.

Conversely, that same player may also find comfort and/or amusement in UGC of past gameplay that resulted in similarly unsuccessful outcomes. Thus, even UGC depicting conventionally unsuccessful gameplay may nevertheless provide entertainment value to certain players. While many UGC of successful gameplay may be alike and present predetermined requirements associated with accruing points, status, or making progress in a given game title, UGC of unsuccessful gameplay may exhibit more variety in the ways in which a player may fail to meet such predetermined requirements. In addition to the difficulty of analyzing UGC for the variety of different reasons that may result in or contribute to failed gameplay, there may also be difficulty in identifying the appropriate audience of users who would have interest in such UGC, as well as in matching the UGC to current gameplay.

Therefore, there is a need to provide a service that provides one or more media files of a past gameplay session associated with an identified trigger point of a current gameplay session.

### SUMMARY OF THE CLAIMED INVENTION

A method for integrating media of past gameplay into overlays is disclosed. The method may include storing information regarding a plurality of trigger points associated with one or more interactive content titles in memory, each trigger point associated with a plurality of possible results of an activity in a respective interactive content title, and each of the possible results associated with one or more media files depicting the associated result of the activity. The method may also include monitoring gameplay data sent over a communication network from a client device of a player engaged in a current activity of one of the interactive content titles within a current gameplay session. The gameplay data may concern gameplay associated with an identified trigger point of the current activity within the current gameplay session. The method may further include identifying that the monitored gameplay data indicates one of the possible results of the identified trigger point associated with the current activity. The method may include filtering the stored media files based on the identified result of the identified trigger point associated with the current activity. One or more filtered media files may be identified as depicting the identified result of the identified activity. The method may include generating an overlay display of at least one of the filtered media files provided to the client device for presentation in association with the current gameplay session.

A system for integrating media of past gameplay into overlays is disclosed. The system includes a memory and a processor that executes instructions stored in memory, wherein execution of the instructions by the processor may store information regarding a plurality of trigger points associated with one or more interactive content titles in memory, each trigger point associated with a plurality of possible results of an activity in a respective interactive content title, and each of the possible results associated with one or more media files depicting the associated result of the activity. The execution of the instructions by the processor also may cause to monitor gameplay data sent over a communication network from a client device of a player engaged in a current activity of one of the interactive content titles within a current gameplay session. The gameplay data may concern gameplay associated with an identified trigger point of the current activity within the current gameplay session. The execution of the instructions by the processor also may identify that the monitored gameplay data indicates one of the possible results of the identified trigger point associated with the current activity. The execution of the instructions by the processor also may cause to filter the stored media files based on the identified result of the identified trigger point associated with the current activity. One or more filtered media files may be identified as depicting the identified result of the identified activity. The execution of the instructions by the processor also may cause to generate an overlay display of at least one of the filtered media files provided to the client device for presentation in association with the current gameplay session.

A non-transitory computer-readable storage medium, having embodied thereon a program executable by a processor to perform a method for integrating media of past gameplay into overlays is disclosed. The method may include storing information regarding a plurality of trigger points associated with one or more interactive content titles in memory, each trigger point associated with a plurality of possible results of an activity in a respective interactive content title, and each of the possible results associated with one or more media files depicting the associated result of the activity. The method may also include monitoring gameplay data sent over a communication network from a client device of a player engaged in a current activity of one of the interactive content titles within a current gameplay session. The gameplay data may concern gameplay associated with an identified trigger point of the current activity within the current gameplay session. The method may further include identifying that the monitored gameplay data indicates one of the possible results of the identified trigger point associated with the current activity. The method may include filtering the stored media files based on the identified result of the identified trigger point associated with the current activity. One or more filtered media files may be identified as depicting the identified result of the identified activity. The method may include generating an overlay display of at least one of the filtered media files provided to the client device for presentation in association with the current gameplay session.

### BRIEF DESCRIPTION OF THE DRAWINGS

FIG. 1 illustrates an exemplary network environment in which a system for providing visual comparisons to previous gameplay may be implemented.

FIG. 2A illustrates an exemplary uniform data system (UDS) that may be used to provide data to a system for providing visual comparisons to previous gameplay.

FIG. 2B illustrates an exemplary table of various objects and associated events.

FIG. 3 is a flowchart illustrating an exemplary method for providing visual comparisons to previous gameplay.

FIG. 4 is a diagram illustrating an exemplary gameplay timeline of trigger points and a media file depicting an identified result that is associated with one of the trigger points.

FIG. 5 is a block diagram of an exemplary electronic entertainment system, according to some aspects of the present disclosure.

### DETAILED DESCRIPTION

Embodiments of the present invention include systems and methods for providing visual comparisons to a previous gameplay by generating an overlay display in a current gameplay session, the overlay display including at least a media file that is selected based on an identified result of an identified trigger point associated with a current activity. The method may include storing information regarding a plurality of trigger points associated with one or more interactive content titles in memory, each trigger point associated with a plurality of possible results of an activity in a respective interactive content title, and each of the possible results associated with one or more media files depicting the associated result of the activity.

The method may also include monitoring gameplay data sent over a communication network from a client device of a player engaged in a current activity of one of the interactive content titles within a current gameplay session. The gameplay data may concern gameplay associated with an identified trigger point of the current activity within the current gameplay session. The method may further include identifying that the monitored gameplay data indicates one of the possible results of the identified trigger point associated with the current activity. The method may include filtering the stored media files based on the identified result of the identified trigger point associated with the current activity. One or more filtered media files may be identified as depicting the identified result of the identified activity. The method may further include generating an overlay display of at least one of the filtered media files provided to the client device for presentation in association with the current gameplay session.

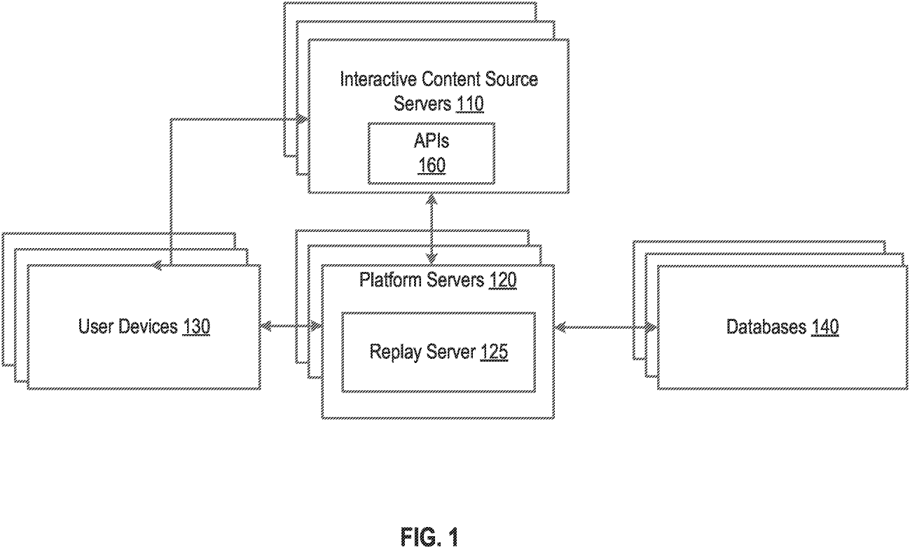

FIG. 1 illustrates an exemplary network environment in which a system for integrating media of past gameplay into overlays may be implemented. The network environment 100 may include one or more interactive content servers 110 that provide streaming content (e.g., interactive video, podcasts, etc.), one or more platform servers 120 including a replay server 125, one or more user devices 130, and one or more databases 140.

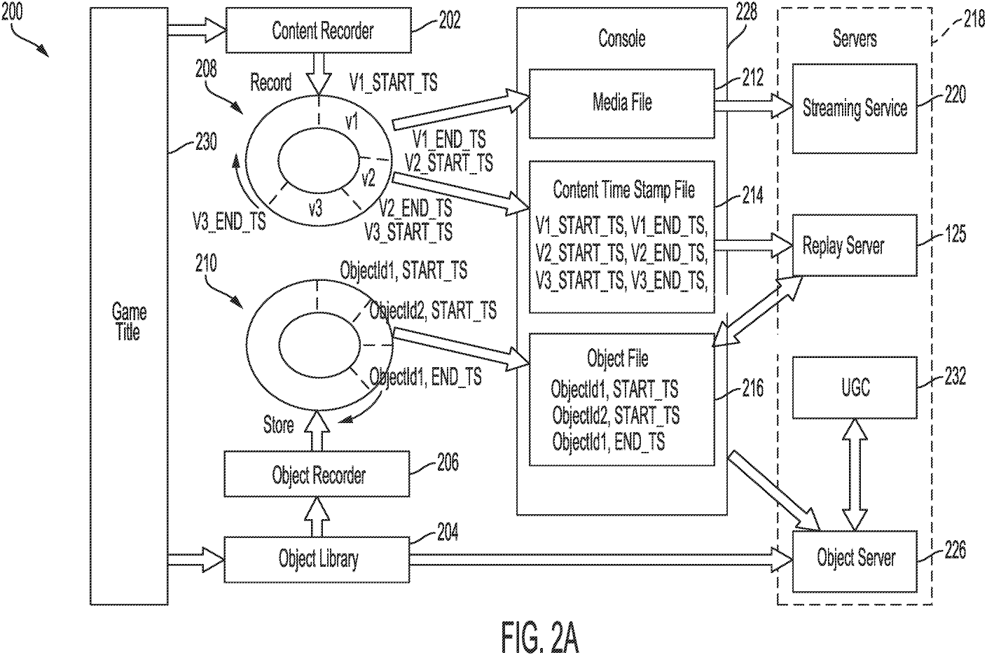

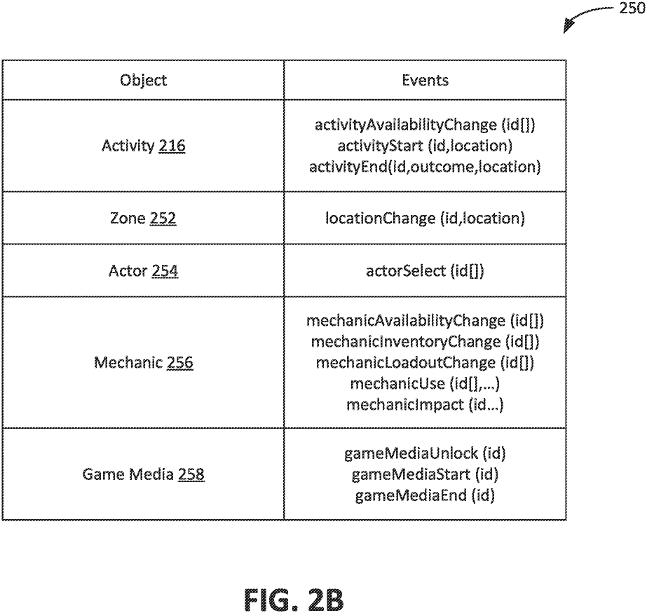

Interactive content servers 110 may maintain, stream, and host interactive media available to stream on a user device 130 over a communication network. Such interactive content servers 110 may be implemented in the cloud (e.g., one or more cloud servers). Interactive media files may include files associated with different game titles or other interactive media titles known in the art. Each media file may include or be associated with one or more sets of object data files that may be available for participation with (e.g., viewing or interacting with an activity) by a user. Data and metadata about the object shown in the media may be stored by the media streaming servers 110, platform servers 120 and/or the user device 130, in an object file 216 (“object file”), as will be discussed in detail with respect to FIG. 2. Each streaming media title may be associated with one or more files that include at least one object set associated with at least a portion of the streaming media title. Each set of object data may have data about an object (e.g., activity information, zone information, mechanic information, game media information, etc.) displayed during at least a portion of the streaming media title.

The platform servers 120 may be responsible for communicating with the different interactive content servers 110, databases 140, and user devices 130. Such platform servers 120 may be implemented on one or more cloud servers. The streaming servers 110 may communicate with multiple platform servers 120, though the media streaming servers 110 may be implemented on one or more platform servers 120. The platform servers 120 may also carry out instructions, for example, receiving a user request from a user to stream streaming media (e.g., games, activities, video, podcasts, User Generated Content (“UGC”), publisher content, etc.). The platform servers 120 may further carry out instructions for retrieving the requested content (e.g., from interactive content source servers 110 or databases 140) and for streaming the retrieved content.

The platform servers 120 may include a replay server 125 that receives gameplay data indicating that one of a plurality of possible results associated with a trigger point was identified based on monitored gameplay data. The interactive content title may include a plurality of predetermined trigger points, and each trigger point or checkpoint may correspond to attempted actions (e.g., attempts to beat a boss, reach an end of a level, or accomplish a task or quest) during a gameplay session. As such, each trigger point may be associated with a plurality of possible results in a respective interactive content title. For example, possible results (aside from winning) for different types of trigger points may include a character death before reaching a next checkpoint, failure to beat a boss, reaching an end of a timed run without beating a level, etc. Each such result indicates that the player may get to or need to replay certain portions of the respective interactive content title in order to achieve success.

The replay server 125 may filter through stored media files based on an identified result of one or more trigger point associated with a current gameplay session. For example, if a current activity is fighting a boss, the identified result may include failure to beat the boss. Specific trigger points may include different predetermined points within the fight, including certain actions or reactions by the player at specified points during the fight. For example, the player may choose certain weapons, fire or implement the weapons (or failure thereof) at crucial or determinative moments, or perform certain moves or maneuvers. A given game title may include different points during gameplay in which choices made by the player determine or contribute to an outcome. The replay server 125—in conjunction with databases 140—may track and aggregate game data associated with different players. Such data may be analyzed to identify such trigger points within the game environment and timeline of a gameplay session. While gameplay sessions may exhibit variability, aggregated gameplay data may indicate certain patterns leading up to an in-game event and outcome.

Replay server 125 may therefore use such trigger points and associated results to filter through stored media files and identify filtered media files that depict the player or other players failing to the beat the boss in the same (or similar) way. An overlay display may be generated to display the filtered media file and provided to a client device for presentation in association with a current gameplay session, such as before the player chooses to replay the activity of fighting the boss. The replay server 125 may also use user-specific filtering criteria to as to identify media files depicting the same or similar failures by designated friends, peers, famous players, or other preferred player type (e.g., similar experience level, similar in-game resources/status).

In some embodiments, the streaming media may be processed via an application programming interface (API) 160 associated with one or more media sources (e.g., interactive content source servers 110, databases 160, as well as third party services such as YouTube® or Twitch®). The media content may be analyzed by replay server 125 to identify one or more trigger points and a result for each of the trigger points identified in the received media files. The resulting analytics may be stored in databases 140 and used by replay server 125 to match the media content (or specific portions thereof) to current gameplay.

In particular, data regarding the identified trigger points and results/outcomes within the media content (and/or specific portions thereof) may also be stored in database 140. The replay server 125 may use such stored data to identify which media content file (from which source and which specific portion) corresponds to current gameplay by a specific user. For example, different media files may correspond to different gameplay sessions that included the player character making it through or dying during different levels or stages of gameplay. Where a current user failed during the early stages of a game title, for example, replay server 125 may filter media files associated with the same game title to identify a specific set of media files depicting failure in the early stages. Replay server 125 may further filter media files with additional levels of granularity as more and more media files are generated and analyzed to identify more specific details associated with the trigger points and outcomes thereof.

Metadata associated with the media files (e.g., associated activity files or object files described in more detail in relation to FIG. 2) may indicate where the player reaches trigger points during the gameplay session. In addition, the activities and/or trigger points may be identified based on computer vision and image recognition via optical scan of the played media files (e.g., images of the virtual environment or any notations in a heads-up display). A current activity or an associated trigger point may even be more quickly determined based on additional discrete codes display on screen that can be scanned, such as a QR code.

The replay server 125 may further determine one or more gameplay attributes associated with the current activity in the current gameplay session and compare the determined gameplay attributes with stored gameplay attributes that are associated with each of the possible results of each activity. For example, if an activity is working together with other players to solve a puzzle under a prescribed period of time, a possible result would be failing to solve the puzzle any number of ways. Gameplay attributes associated with failing to finish the activity may include, for example, being only a few steps away from solving the puzzle but not seeing it or having a low score despite a lot of movement and activity amongst the players. Other kinds of gameplay attributes may be associated with, for example, at least one of a score, an attempted difficulty level, a combination of inputs, a level of player, audio level from the players indicating excitement or chaos, and a rating of a respective media by other player accounts. The identified result may be associated with a highest level of similarity in gameplay attributes. For example, the identified result may be an indication that the players are beginners and are having a hard time solving the puzzle, based on the gameplay attribute of having a low score despite a lot of movement and activity amongst the players and a low level in most of the players.

The replay server 125 may further select a filtered media file from a plurality of filtered media files based on the filtered media file exhibiting gameplay attributes having a highest level of similarity to the determined gameplay attributes. Following the example above, the selected media file may be another group of players also scrabbling around having a hard time solving the puzzle based on similarly low level of skill in the players and lots of movement but little scoring. The selected media file may also have been viewed by others and upvoted or downvoted for being a funny or useful clip associated with the activity and displayed after other players failed to solve the puzzle as well.

The streaming media and the associated at least one set of object data may be provided through the application programming interface (API) 160, which allows various types of media streaming servers 110 to communicate with different platform servers 120 and different user devices 130. API 160 may be specific to the particular computer programming language, operating system, protocols, etc., of the media streaming servers 110 providing the streaming media content titles, the platform servers 120 providing the media and the associated at least one set of object data, and user devices 130 receiving the same. In a network environment 100 that includes multiple different types of media streaming servers 110 (or platform servers 120 or user devices 130), there may likewise be a corresponding number of APIs 160.

The user device 130 may include a plurality of different types of computing devices. For example, the user device 130 may include any number of different gaming consoles, mobile devices, laptops, and desktops. In another example, the user device 130 may be implemented in the cloud (e.g., one or more cloud servers). Such user device 130 may also be configured to access data from other storage media, such as, but not limited to memory cards or disk drives as may be appropriate in the case of downloaded services. Such devices 130 may include standard hardware computing components such as, but not limited to network and media interfaces, non-transitory computer-readable storage (memory), and processors for executing instructions that may be stored in memory. These user devices 130 may also run using a variety of different operating systems (e.g., iOS, Android), applications or computing languages (e.g., C++, JavaScript). The user device may include one or more devices associated with a user or a user device capable of displaying on one or more screens.

The databases 140 may be stored on the platform servers 120, the media streaming servers 110, any of the servers 218 (shown in FIG. 2), on the same server, on different servers, on a single server, across different servers, or on any of the user devices 130. Such databases 140 may store the streaming media and/or an associated set of object data. Such streaming media may depict one or more objects (e.g., activities) that a user can participate in or interact with. One or more user profiles may also be stored in the databases 140. Each user profile may include information about the user (e.g., user progress in an activity and/or media content title, user id, user game characters, etc.) and may be associated to media.

In an exemplary embodiment of the present invention, platform servers 120 may capture data regarding current gameplay sessions. One current gameplay session may include a user using user device 130 to access and engage with an interactive content title hosted by interactive content servers 110. During gameplay of a particular game title, for example, platform servers 120 may record gameplay data (including video, metadata regarding in-game status and actions, etc.) sufficient to form one or more media-object bindings between at least one set of object data and a media file associated with the current gameplay. As such, the selected media file may be based on a comparison of the comparison of object data associated with the media files being filtered.

Data regarding the particular in-game activity may also be captured (and described in further detail in relation to FIG. 2) and stored in database(s) 140. Data regarding the activities, trigger points, and results may include one or more gameplay attributes in common. Such gameplay attributes may be associated with similar scores, an attempted difficulty level, a combination of inputs, a level of player, and a rating of a respective media by other player accounts, or other element of the digital environment of the game title. As such, a highest level of similar of gameplay attributes may be measured between determined gameplay attributes of a current gameplay session and possible gameplay attributes associated with the respective activity being played in the same interactive content title. The similarity of gameplay attributes may further be compared between the current gameplay session and those associated with the stored media files associated with the same activity being played in the same interactive content title.

In an exemplary implementation, databases 140 may store information regarding a plurality of past and current gameplay sessions, including the associated activities, trigger points, results, and gameplay attributes that have been identified within each corresponding media file. Platform servers 120 may further analyze gameplay data from a current gameplay session associated with a specific player in real-time to identify when the trigger points occur and to compare data associated with the identified trigger points to corresponding trigger points in one or more media files associated with past gameplay sessions. Such analysis may further include evaluation in comparison to historical gameplay data and metadata of the same player or of other players of the same or similar game titles as stored in databases 140.

FIG. 2A illustrates an exemplary uniform data system (UDS) that may be used to provide data to a system for integrating media of past gameplay into overlays. Based on data provided by UDS, the projection server 125 can be made aware of what in-game objects, entities, activities, and events that users have engaged with, and thus support analysis of and coordination with in-game activities. Each user interaction may be associated the metadata for the type of in-game interaction, location within the in-game environment, and point in time within an in-game timeline, as well as other players, objects, entities, etc., involved. Thus, metadata can be tracked for any of the variety of user interactions that can occur in during a game session, including associated activities, entities, settings, outcomes, actions, effects, locations, and character stats. Such data may further be aggregated, applied to data models, and subject to analytics. Such a UDS data model may be used to assign contextual information to each portion of information in a unified way across games.

As illustrated in FIG. 2A, an exemplary console 228 (e.g., a user device 130) and exemplary servers 218 (e.g., streaming server 220, the projection server 125, a user-generated content (UGC) server 232, and an object server 226) are shown. In one example, the console 228 may be implemented on the platform servers 120, a cloud server, or on any of the servers 218. In an exemplary example, a content recorder 202 may be implemented on the platform servers 120, a cloud server, or on any of the servers 218. Such content recorder 202 receives and records content (e.g., media) from an interactive content title 230 onto a content ring-buffer 208. Such ring-buffer 208 may store multiple content segments (e.g., v1, v2 and v3), start times for each segment (e.g., V1_START_TS, V2_START_TS, V3_START_TS), and end times for each segment (e.g., V1_END_TS, V2_END_TS, V3_END_TS). Such segments may be stored as a media file 212 (e.g., MP4, WebM, etc.) by the console 228. Such media file 212 may be uploaded to the streaming server 220 for storage and subsequent streaming or use, though the media file 212 may be stored on any server, a cloud server, any console 228, or any user device 130. Such start times and end times for each segment may be stored as a content time stamp file 214 by the console 228. Such content time stamp file 214 may also include a streaming ID, which matches a streaming ID of the media file 212, thereby associating the content time stamp file 214 to the media file 212. Such content time stamp file 214 may be sent to the projection server 125 and/or the UGC server 232, though the content time stamp file 214 may be stored on any server, a cloud server, any console 228, or any user device 130.

Concurrent to the content recorder 202 receiving and recording content from the interactive content title 230, an object library 204 receives data from the interactive content title 230, and an object recorder 206 tracks the data to determine when an object begins and ends. The object library 204 and the object recorder 206 may be implemented on the platform servers 120, a cloud server, or on any of the servers 218. When the object recorder 206 detects an object beginning, the object recorder 206 receives object data (e.g., if the object were an activity, user interaction with the activity, activity ID, activity start times, activity end times, activity results, activity types, etc.) from the object library 204 and records the object data onto an object ring-buffer 210 (e.g., ObjectID1, START_TS; ObjectID2, START_TS; ObjectID3, START_TS). Such object data recorded onto the object ring-buffer 210 may be stored in the object file 216. Such object file 216 may also include activity start times, activity end times, an activity ID, activity results, activity types (e.g., tutorial interaction, menu access, competitive match, quest, task, etc.), user or peer data related to the activity. For example, an object file 216 may store data regarding an in-game skill used, an attempt to use a skill, or success or failure rate of using a skill during the activity. Such object file 216 may be stored on the object server 226, though the object file 216 may be stored on any server, a cloud server, any console 228, or any user device 130.

Such object data (e.g., the object file 216) may be associated with the content data (e.g., the media file 212 and/or the content time stamp file 214). In one example, the UGC server 232 stores and associates the content time stamp file 214 with the object file 216 based on a match between the streaming ID of the content time stamp file 214 and a corresponding activity ID of the object file 216. In another example, the object server 226 may store the object file 216 and may receive a query from the UGC server 232 for an object file 216. Such query may be executed by searching for an activity ID of an object file 216 that matches a streaming ID of a content time stamp file 214 transmitted with the query. In yet another example, a query of stored content time stamp files 214 may be executed by matching a start time and end time of a content time stamp file 214 with a start time and end time of a corresponding object file 216 transmitted with the query. Such object file 216 may also be associated with the matched content time stamp file 214 by the UGC server 232, though the association may be performed by any server, a cloud server, any console 228, or any user device 130. In another example, an object file 216 and a content time stamp file 214 may be associated by the console 228 during creation of each file 216, 214.

The activity files captured by UDS 200 may be accessed by the platform servers 120 as to the user, the game title, the specific activity being engaged by the user in a game environment of the game title, and similar users, game titles, and in-game activities. Such data may be compared to data from the current gameplay session to identify with granularity how the user may be struggling. For example, the platform servers 120 may identified that players successfully engaging in the same activity may have performed a particular move associated with a specific combination of input, while also identifying that user input appears to be similar but does not quite match the specific combo. The platform servers 120 may therefore filter the available training materials to identify the materials relevant to the specific combo (e.g., controller layout with the specific input buttons marked or numbered, video of past players who used the combo, tips associated with the combo). The filtered training materials may further be provided to the user in accordance with a profile that includes express preferences and historical habits.

FIG. 2B illustrates an exemplary table of various objects and associated events. As shown in the exemplary table 250 of FIG. 2B, such object data (e.g., the object file 216) may be associated with event information regarding activity availability change and may be related to other objects with associated event information. For example, such object data may be zone data files 252, actor data files 254, mechanics data files 256, game media data files 258, and other gameplay-related data files.

Such object data (e.g., the object file 216) may be categorized as in in progress, openended, or competitive. Such object data files 216 may include optional properties, such as a longer description of the activity, an image associated with the activity, if the activity is available to players before launching the game, whether completion of the activity is required to complete the game, whether the activity can be played repeatedly in the game, and whether there are nested tasks or associated child activities. Such object data files 216 may include an activity availability change event for, which may indicate a list or array of currently available activities for the player. For example, this may be used to decide what activities to display in a game plan.

Such zone data files 252 may indicate an area of an associated game world with a single coordinate system wherein the zone may have a 2-D map associated with it, and may be used to display locations on the zone. If zone data files 252 are applicable, each zone may include a zone ID and a short localizable name of the Zone. Such zone data files 252 may be associated with a view projection matrix (4x4) to convert from 3-D world coordinates to a 2-D map position. Such zone data files 252 may be associated with a location change event that indicates an update to a current in-game location of the player. Such location change event may be posted regularly, or whenever the player’s in-game location changes significantly. The platform servers 120 may store a latest value in ‘state.’ Such zone data files 252 may include an x, y, z position of the player’s character in the zone as well as an a, b, c vector indicating the player’s characters orientation or direction. Such zone data files 252 may be associate with an activity start event and/or an activity end event and for the activity end event, an outcome of completed, failed, or abandoned may be associated to the activity (e.g., activity ID).

Such actor data files 254 may be associated with an entity with behaviors in the game and can be player-controller or game-controlled, and can change dynamically during gameplay. Such actor data files 254 may include an actor ID for the actor, a localizable name for the actor, an image of the actor, and/or a short description of the actor. Such actor data files 254 may be associated with an actor select event that indicates that the player’s selected actor(s) have changed. The selected actor(s) may represent the actors the player is controlling in the game and may be displayed on the player’s profile and other spaces via the platform servers 120. There may be more than one actor selected at time and each game may replace its list of actors upon loading save data.

Such mechanics data files 256 may be associated with an item, skill, or effect that can be used by the player or the game to impact gameplay (e.g., bow, arrow, stealth attack, fire damage) and may exclude items that do no impact gameplay (e.g., collectibles). Such mechanics data files 256 may include a mechanic ID of the mechanic, a short name of the mechanic, an image of the mechanic, and/or a short description of the mechanic. Such mechanics data files 256 may be associated with a mechanic availability change event that indicates that the mechanics available to the player have changed. Available may mean that the mechanic is available in the game world for the player to use, but may require the player to go through some steps to acquire it into inventory (e.g., buy from a shop, pick up from the world) before using it. Each game may replace its list of mechanics upon loading save data.

Such mechanics data files 256 may be associated with a mechanic inventory change event that indicates that the player’s inventory has changed. Inventory may refer to mechanics that are immediately usable to the player without having to take additional steps in the game before using it. Inventory information is used to estimate a player’s readiness for various activities, which may be forwarded to the platform servers 120. Games may replace its list of mechanic inventory upon loading save data. Mechanics on cool down may be considered part of the inventory. Mechanic counts (e.g., ammunition, healing points) with any non-zero value may be treated as “in inventory.” Inventory mechanics may be considered a subset of available mechanics.

Such mechanics data files 256 may be associated with a mechanic use event that indicates that a mechanic has been used by or against the player and may be used to be displayed as mechanic usage in a UGC context. Such mechanics data files 256 may include a list or array of mechanics that were used (e.g, fire arrow, fire damage) or whether an initiator is the player, such that whether the mechanics were used by or against the player. Such mechanics data files 256 may include an initiator actor ID, a current zone ID of the initiator actor, and/or a current x, y, z position of the initiator actor. Such mechanics data files 256 may be associated with a mechanic impact event that indicates that a mechanic had impact on gameplay (e.g., an arrow hit an enemy) and may be used to display mechanic image in a UGC context. Mechanic use and mechanic image events may be not linked. Such mechanics data files 256 may include the initiator action ID, the current zone ID of the initiator actor, the current x, y, z position of the initiator actor, a target actor ID, a current zone ID of the target actor, a current x, y, z of the target actor, and a mitigation mechanic that may mitigate the initiator mechanic.

Such game media data files 258 may be include a game media ID of the game media, a localizable name for the game media, a media format (e.g., image, audio, video, text, etc.), a category or type of media (cut-scene, audiolog, poster, developer commentary, etc.), a URL or a server-provisioned media file, and/or whether the game media is associated with a particular activity. Such game media data files 258 may be associated with a game media start event that indicates that a particular piece of game media has started in the game right now and a game media end event that indicates that the particular piece of game media has ended.

Object data (e.g., activity data, zone data, actor data, mechanics data, etc.) may be associated with one another to form object-object associations. The object data may also be associated with the media files (e.g., media file 212) and for media-object bindings. These object-object associations and media-object bindings, along with other associations made with respect to aspects (e.g., activities, actors, actions, etc.) displayed in the media, may indicate particular patterns such that future object data may be predicted based on such associations that form object aggregations. Object aggregations may form one or more relationships between the object data through algorithms, logic functions, statistical analysis, and other dataset analyses.

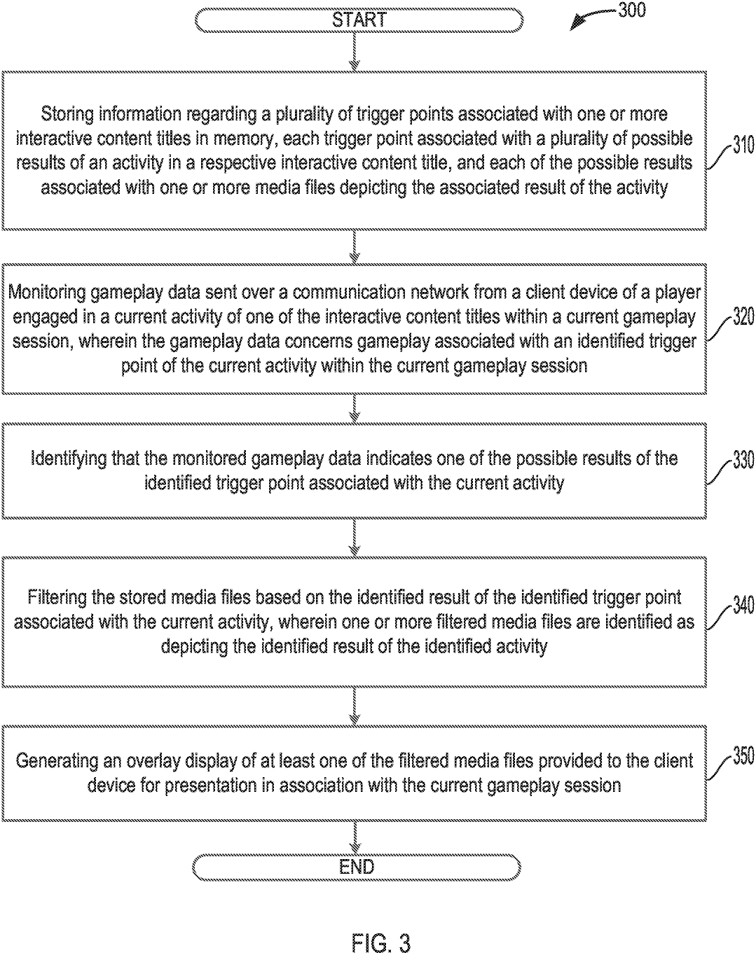

FIG. 3 is a flowchart illustrating an exemplary method for providing visual comparisons to previous gameplay. The steps identified in FIG. 3 are exemplary and may include various alternatives, equivalents, or derivations thereof including but not limited to the order of execution of the same. The steps of the process of FIG. 3 and any alternative similar processes may be embodied in hardware or software including a computer-readable storage medium including instructions executable by the likes of a processor in a computing device.

In step 310, information regarding a plurality of trigger points associated with one or more interactive content titles may be stored in memory. Each trigger point may be associated with a plurality of possible results of an activity in a respective interactive content title. Upon reaching a possible result of an activity, the trigger point may be reached within a gameplay timeline. For example, the activity may be a boss fight and a possible result of the boss fight is to be killed by the boss, such that once the player is killed by the boss, the trigger point is reached. Furthermore, each of the possible results may be associated with one or more media files depicting the associated result of the activity. There may be media files associated with a possible result of beating the boss and other media files associated with another possible result of failing to beat the boss.

In step 320, gameplay data sent over a communication network from a client device of a player engaged in a current activity of one of the interactive content titles within a current gameplay session may be monitored. The gameplay data may concern gameplay associated with an identified trigger point of the current activity within the current gameplay session. The gameplay data may include or be indicative of object data, such as activity data, zone data, actor data, mechanics data, that indicates where the player’s character is in a virtual environment, what kinds of activities or actions the character is performing, what kind of player characters and non-player characters are relevant, and what kinds of items or tools are being used. Such data may be monitored and indicate the current activity as well as an associated trigger point.

In step 330, the monitored gameplay data may be identified to indicate one of the possible results of the identified trigger point associated with the current activity. The current activity may be, for example, fighting a boss, platforming, solving a clue in an escape room, etc. There may be different results for each of these activities. For fighting a boss, the player may win by a lot, fail by a lot, barely win, barely lose, etc. Platforming may result in, for example, the player missing a jump by just a little causing the player’s character to die, missing an important combination move causing the player’s character to die, just making a jump based on seamless coordinate with another player in a co-op game. After experiencing the results that cause the player to need to replay the current activity, usually linking to some kind of failure or death in the attempt of the current activity, the player may be in need of some comic relief or solace after losing, for example, a hard battle. As such, the player would appreciate watching other or their own previous attempts of the same activity and with similar results, such as also just missing a final jump by just a little, or with having similar aspects associated with their results, having a high score and attempted difficulty level.

In step 340, the stored media files may be filtered based on the identified result of the identified trigger point associated with the current activity. The stored media files may be associated with past gameplay sessions by the player or other players. One or more filtered media files may be identified as depicting the identified result of the identified activity. The one or more filtered media files may be identified based on a highest level of similarity of exhibiting gameplay attributes in comparison to determined gameplay attributes of the current activity.

In step 350, an overlay display of at least one of the filtered media files may be generated and provided to the client device for presentation in association with the current gameplay session. The overlay display may be set as a default pop-up that automatically plays one of the filtered media files or may require the player to opt-in to receive such filtered media files upon reaching a trigger point. The overlay display may include an option to rate the displayed media file such that replay server 125 may learn whether or not that displayed media file was relevant to the player and/or whether the displayed media file was a good candidate as comic relief for other players.

In some embodiments, a new media file, may be received via an application programming interface associated with one or more media sources. The new media file may be analyzed to identify one or more of the trigger points and a result for each of the trigger points identified in the new media file. The new media file may be a video file recording of a gameplay session and may further include concurrent streaming of the player playing the gameplay session, as well as other kinds of streaming content. The new media file may be stored in memory and stored in association with the identified trigger points in the new media file and the identified result for each of the identified trigger points in the new media file. Associating the identified trigger points and identified result for each of the identified trigger points allow the new media to be selected through filtering of a plurality of media files when the identified trigger point of a current activity matches.

In some embodiments, the stored information may further include one or more gameplay attributes associated with each of the possible results of the identified activity. Identifying that the monitored data indicates the identified result may include determining one or more gameplay attributes associated with the current activity in the current gameplay session and comparing the determined gameplay attributes to the stored gameplay attributes for the current activity, wherein the identified result is associated with a highest level of similarity in gameplay attributes.

In some embodiments, the at least one filtered media file may be selected from from among a plurality of filtered media files based on the at least one filtered media file exhibiting gameplay attributes having a highest level of similarity to the determined gameplay attributes.

In some embodiments, the determined gameplay attributes may include at least one set of object data. The stored information may further include one or more sets of object data associated with each of the media files. Furthermore, one or more media-object bindings may be formed between the at least one set of object data and a media file associated with the current gameplay. Selecting the at least one filtered media file may be based on a comparison of the at least one set of object data to another set of object data associated with the at least one filtered media file.

In some embodiments, the gameplay attributes may include at least one of a score, an attempted difficulty level, a combination of inputs, a level of player, and a rating of a respective media by other player accounts.

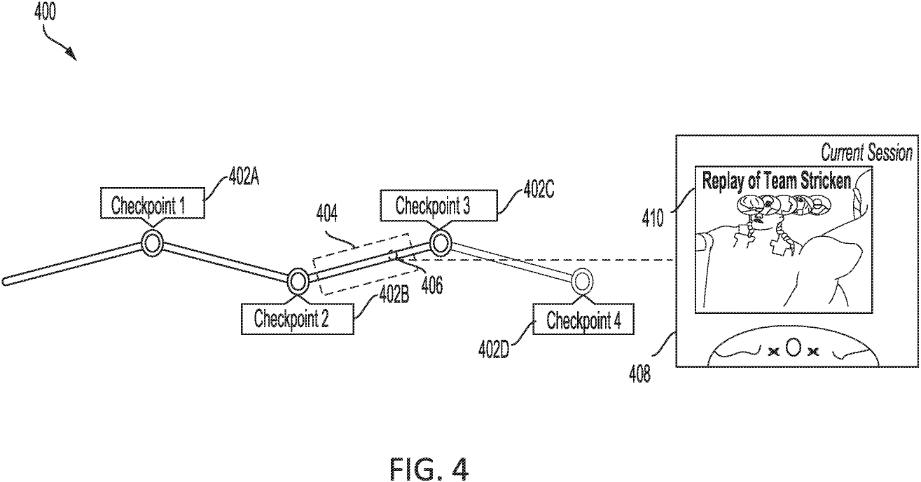

FIG. 4 is a diagram illustrating an exemplary gameplay timeline of trigger points and a media file depicting an identified result that is associated with one of the trigger points. A gameplay timeline 400 may include various checkpoints that require, for example, that a task be accomplished, a boss be beat, a timed run be completed, etc. As shown in the gameplay timeline 400, there is checkpoint 1 402A, checkpoint 2 402B, checkpoint 3 402C, and checkpoint 4 403D. As shown in FIG. 4, the player is currently playing a current activity 404 between checkpoint 2 402B and checkpoint 3 402C. At trigger point 406, the player reaches a possible result, for example, failing to beat the boss required to pass checkpoint 3 402C. As such, an overlay display 410 of a filtered media file may be displayed in a current session 408 at a client device. The overlay display 410 may be a replay for another team “Team Stricken” attempting to beat the same boss and sharing similar gameplay attributes as that of the current activity.

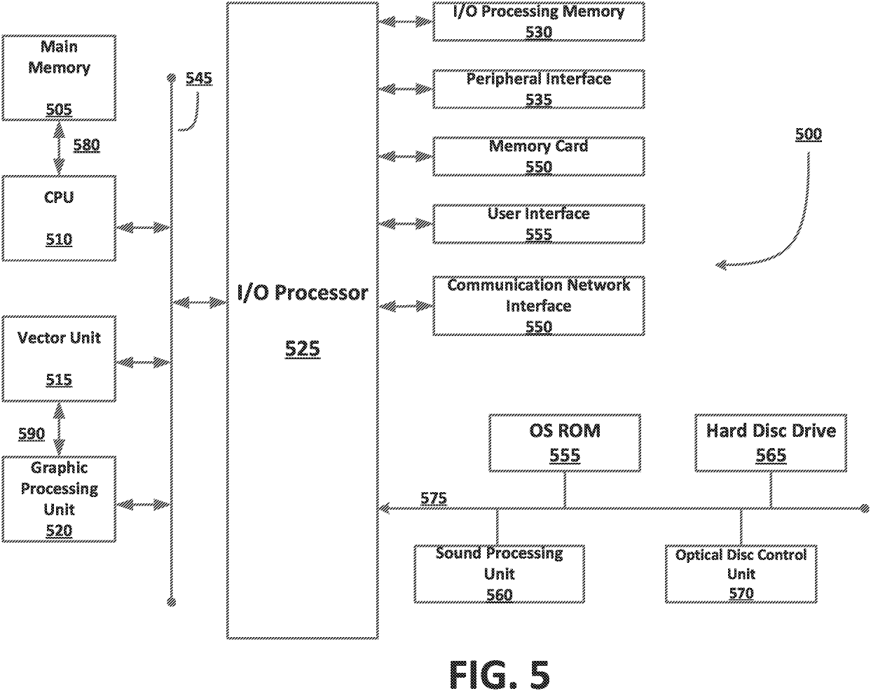

FIG. 5 is a block diagram of an exemplary electronic entertainment system that may be used in embodiments of the present invention. The entertainment system 500 of FIG. 5 includes a main memory 505, a central processing unit (CPU) 510, vector unit 515, a graphics processing unit 520, an input/output (I/O) processor 525, an I/O processor memory 530, a controller interface 535, a memory card 540, a Universal Serial Bus (USB) interface 545, and an IEEE interface 550. The entertainment system 500 further includes an operating system read-only memory (OS ROM) 555, a sound processing unit 560, an optical disc control unit 570, and a hard disc drive 565, which are connected via a bus 575 to the I/O processor 525.

Entertainment system 500 may be an electronic game console. Alternatively, the entertainment system 500 may be implemented as a general-purpose computer, a set-top box, a hand-held game device, a tablet computing device, or a mobile computing device or phone. Entertainment systems may contain more or less operating components depending on a particular form factor, purpose, or design.

The CPU 510, the vector unit 515, the graphics processing unit 520, and the I/O processor 525 of FIG. 5 communicate via a system bus 555. Further, the CPU 510 of FIG. 5 communicates with the main memory 505 via a dedicated bus 580, while the vector unit 515 and the graphics processing unit 520 may communicate through a dedicated bus 590. The CPU 510 of FIG. 5 executes programs stored in the OS ROM 555 and the main memory 505. The main memory 505 of FIG. 5 may contain pre-stored programs and programs transferred through the I/O Processor 525 from a CD-ROM, DVD-ROM, or other optical disc (not shown) using the optical disc control unit 570. I/O Processor 525 of FIG. 5 may also allow for the introduction of content transferred over a wireless or other communications network (e.g., LTE, 3G, and so forth). The I/O processor 525 of FIG. 5 primarily controls data exchanges between the various devices of the entertainment system 500 including the CPU 510, the vector unit 515, the graphics processing unit 520, and the controller interface 535.

The graphics processing unit 520 of FIG. 5 executes graphics instructions received from the CPU 510 and the vector unit 515 to produce images for display on a display device (not shown). For example, the vector unit 515 of FIG. 5 may transform objects from three-dimensional coordinates to two-dimensional coordinates, and send the two-dimensional coordinates to the graphics processing unit 520. Furthermore, the sound processing unit 560 executes instructions to produce sound signals that are outputted to an audio device such as speakers (not shown). Other devices may be connected to the entertainment system 500 via the USB interface 545, and the IEEE 594 interface 550 such as wireless transceivers, which may also be embedded in the system 500 or as a part of some other component such as a processor.

A user of the entertainment system 500 of FIG. 5 provides instructions via the controller interface 535 to the CPU 510. For example, the user may instruct the CPU 510 to store certain game information on the memory card 540 or other non-transitory computer-readable storage media or instruct a character in a game to perform some specified action.

The present invention may be implemented in an application that may be operable by a variety of end user devices. For example, an end user device may be a personal computer, a home entertainment system (e.g., Sony PlayStation2® or Sony PlayStation3® or Sony PlayStation4® or Sony PlayStation5®), a portable gaming device (e.g., Sony PSP® or Sony Vita®), or a home entertainment system of a different albeit inferior manufacturer. The present methodologies described herein are fully intended to be operable on a variety of devices. The present invention may also be implemented with cross-title neutrality wherein an embodiment of the present system may be utilized across a variety of titles from various publishers.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for integrating media of past gameplay into overlays, the method comprising:
storing information regarding a plurality of trigger points associated with one or more interactive content titles in memory, each trigger point associated with a plurality of possible results of an activity in a respective interactive content title, and each of the possible results associated with one or more media files depicting the associated result of the activity;
monitoring gameplay data sent over a communication network from a client device of a player engaged in a current activity of one of the interactive content titles within a current gameplay session, wherein the gameplay data concerns gameplay associated with an identified trigger point of the current activity within the current gameplay session;
identifying that the monitored gameplay data indicates one of the possible results of the identified trigger point associated with the current activity;
filtering the stored media files based on the identified result of the identified trigger point associated with the current activity, wherein one or more filtered media files are identified as depicting the identified result of the identified activity; and
generating an overlay display of at least one of the filtered media files provided to the client device for presentation in association with the current gameplay session.

2. The method of claim 1, further comprising storing a plurality of media files associated with past gameplay sessions in memory, the stored media files associated with past gameplay by the player or by other players.

3. The method of claim 2, further comprising:
receiving a new media file via an application programming interface associated with one or more media sources;
analyzing the new media file to identify one or more of the trigger points and a result for each of the trigger points identified in the new media file; and
storing the new media file in memory, the new media file stored in association with the identified trigger points in the new media file and the identified result for each of the identified trigger points in the new media file.

4. The method of claim 1, wherein the stored information further includes one or more gameplay attributes associated with each of the possible results of the identified activity, and wherein identifying that the monitored data indicates the identified result includes:
determining one or more gameplay attributes associated with the current activity in the current gameplay session; and
comparing the determined gameplay attributes to the stored gameplay attributes for the current activity, wherein the identified result is associated with a highest level of similarity in gameplay attributes.

5. The method of claim 4, further comprising selecting the at least one filtered media file from among a plurality of filtered media files based on the at least one filtered media file exhibiting gameplay attributes having a highest level of similarity to the determined gameplay attributes.

6. The method of claim 5, wherein the determined gameplay attributes include at least one set of object data, wherein the stored information further includes one or more sets of object data associated with each of the media files, and further comprising:
forming one or more media-object bindings between the at least one set of object data and a media file associated with the current gameplay, wherein selecting the at least one filtered media file is based on a comparison of the at least one set of object data to another set of object data associated with the at least one filtered media file.

7. The method of claim 4, wherein the gameplay attributes include at least one of a score, an attempted difficulty level, a combination of inputs, a level of player, and a rating of a respective media by other player accounts.

8. The method of claim 7, further comprising updating the generated overlay display to include an option to rate the at least one filtered media file.

9. A system for integrating media of past gameplay into overlays, comprising:
memory that stores information regarding a plurality of trigger points associated with one or more interactive content titles in memory, each trigger point associated with a plurality of possible results of an activity in a respective interactive content title, and each of the possible results associated with one or more media files depicting the associated result of the activity; and
a processor that executes instructions stored in memory, wherein the processor executes the instructions to:
monitor gameplay data sent over a communication network from a client device of a player engaged in a current activity of one of the interactive content titles within a current gameplay session, wherein the gameplay data concerns gameplay associated with an identified trigger point of the current activity within the current gameplay session;
identify that the monitored gameplay data indicates one of the possible results of the identified trigger point associated with the current activity;
filter the stored media files based on the identified result of the identified trigger point associated with the current activity, wherein one or more filtered media files are identified as depicting the identified result of the identified activity; and
generate an overlay display of at least one of the filtered media files provided to the client device for presentation in association with the current gameplay session.

10. The system of claim 9, wherein the memory further stores a plurality of media files associated with past gameplay sessions in memory, the stored media files associated with past gameplay by the player or by other players.

11. The system of claim 10, further comprising a communication interface that communicates over a communication network to receive a new media file via an application programming interface associated with one or more media sources, wherein the processor executes further instructions to analyze the new media file to identify one or more of the trigger points and a result for each of the trigger points identified in the new media file, and wherein the memory further stores the new media file, the new media file stored in association with the identified trigger points in the new media file and the identified result for each of the identified trigger points in the new media file.

12. The system of claim 9, wherein the stored information further includes one or more gameplay attributes associated with each of the possible results of the identified activity, and wherein the processor identifies that the monitored data indicates the identified result by:
determining one or more gameplay attributes associated with the current activity in the current gameplay session; and
comparing the determined gameplay attributes to the stored gameplay attributes for the current activity, wherein the identified result is associated with a highest level of similarity in gameplay attributes.

13. The system of claim 12, wherein the processor execute further instructions to select the at least one filtered media file from among a plurality of filtered media files based on the at least one filtered media file exhibiting gameplay attributes having a highest level of similarity to the determined gameplay attributes.

14. The system of claim 13, wherein the determined gameplay attributes include at least one set of object data, wherein the stored information further includes one or more sets of object data associated with each of the media files, and wherein the processor executes further instructions to form one or more media-object bindings between the at least one set of object data and a media file associated with the current gameplay, wherein selecting the at least one filtered media file is based on a comparison of the at least one set of object data to another set of object data associated with the at least one filtered media file.

15. The system of claim 12, wherein the gameplay attributes include at least one of a score, an attempted difficulty level, a combination of inputs, a level of player, and a rating of a respective media by other player accounts.

16. The system of claim 15, wherein the processor executes further instructions to update the generated overlay display to include an option to rate the at least one filtered media file.

17. A non-transitory computer-readable storage medium having embodied thereon instructions executable by a computing system to perform a method for method for integrating media of past gameplay into overlays, the method comprising
storing information regarding a plurality of trigger points associated with one or more interactive content titles in memory, each trigger point associated with a plurality of possible results of an activity in a respective interactive content title, and each of the possible results associated with one or more media files depicting the associated result of the activity;
monitoring gameplay data sent over a communication network from a client device of a player engaged in a current activity of one of the interactive content titles within a current gameplay session, wherein the gameplay data concerns gameplay associated with an identified trigger point of the current activity within the current gameplay session;
identifying that the monitored gameplay data indicates one of the possible results of the identified trigger point associated with the current activity;
filtering the stored media files based on the identified result of the identified trigger point associated with the current activity, wherein one or more filtered media files are identified as depicting the identified result of the identified activity; and
generating an overlay display of at least one of the filtered media files provided to the client device for presentation in association with the current gameplay session.
